(19) United States
(12) Patent Application Publication
(10) Pub. No.: US 2011/0231966 A1
(43) Pub. Date: Sep. 22, 2011

(54) SCANNING PROBE MICROSCOPY WITH SPECTROSCOPIC MOLECULAR RECOGNITION

(76) Inventors: Ali Passian, Knoxville, TN (US); Laurene Tetard, Knoxville, TN (US); Thomas George Thundat, Knoxville, TN (US); Brian Henry Davison, Knoxville, TN (US); Martin Keller, Knoxville, TN (US)

(21) Appl. No.: 12/726,118

(22) Filed: Mar. 17, 2010

(51) Int. Cl. G01Q 60/00; G01N 29/04

(52) U.S. Cl. 850/21; 73/584

(57) ABSTRACT

A method for determining chemical characteristics of a sample, the method including directly applying a first acoustic wave at a first frequency to a probe and applying, independent of the directly applying the first acoustic wave, a second acoustic wave at a second frequency to the sample, wherein the first frequency is different than the second frequency and the first acoustic wave and the second acoustic wave are simultaneously applied to the probe and the sample, respectively, and form a coupling. The method further including applying electromagnetic energy to the sample, wherein the electromagnetic energy is absorbed by the sample causing a change in phase of the second acoustic wave. The method further including detecting an effect of the coupling and determining a spectrum of the sample based on the detecting.

This invention was made with government support under Contract No. DE-ACO5-00OR22725 awarded by the U.S. Department of Energy. The government has certain rights in the invention.

### BACKGROUND OF THE INVENTION

1. Field of the Invention

The present invention relates generally to scanning probe microscopy and more particularly to a Scanning Near-field Acoustic Photothermal/photoacoustic Spectroscopy (SNAPS) imaging tool.

2. Discussion of Related Art

### Atomic Force Microscopy

Atomic force microscopy (AFM) is a well established technique for imaging surface features with nanometer or even sub-nanometer resolution. In atomic force microscopy, a cantilever with a small spring constant is dragged on the surface of a sample. The cantilever has a probe tip capable of contacting the sample with a nanometer contact area. The contact force between the tip and the sample includes short-range forces, such as the van der Walls force. Therefore, any small variation in distance between the probe tip and the surface of the sample can result in a large change in the force due to the short range nature of the forces.

When the cantilever is rastered on the top of the surface of the sample, deflection of the cantilever generates a response that creates a spatial force image of the surface with nanometer spatial resolution. However, conventional microscopy is limited only to surface topography. Also, conventional atomic force microscopy is incapable of chemical differentiation of surface features.

### Scanning Near Field Ultrasound Holography (SNFUH)

While atomic force microscopy provides no information concerning chemistry of the features, this limitation can be overcome using the recent development of Scanning Near-field Ultrasound Holography (SNFUH) by Shekhawat and Dravid, which can provide surface and subsurface features. The principle of acoustic holography is simple. The sample in an atomic force microscope is vibrated at MHz frequencies using a sample mount that includes a first piezoelectric crystal. The ultrasonic waves traveling through the sample couple with the motion of the atomic force microscope's cantilever that is in contact with the surface of the sample. Since the atomic force microscope's cantilever is independently vibrated by a second piezoelectric crystal at a slightly different frequency than the ultrasonic waves generated by the first piezoelectric crystal, superposition of the two separate oscillations creates a difference frequency that can be monitored using a position sensitive detector (PSD) of the atomic force microscope. When the phase of the oscillations at this difference frequency is displayed as a function of spatial location of the scanning cantilever tip, the resulting phase image map shows contrast due to acoustic impedance variation caused by material inhomogeneity of the subsurface or surface feature.

### Photoacoustic Spectroscopy

Photoacoustic technique has been well known ever since Alexander Graham Bell first observed the effect using selenium in 1881. In photoacoustic spectroscopy (PAS), an acoustic signal is produced when the sample is exposed to a pulse of light of a certain wavelength. The intensity of the acoustic signal depends on the optical absorption properties of the sample. The acoustic signal strength as a function of optical wavelength shows a unique spectrum of the sample. PAS is an excellent technique for spectroscopic characterization of samples, for example, biological specimens.

### OBJECTS AND SUMMARY OF THE INVENTION

One aspect of the present invention regards an analysis system for determining chemical characteristics of a sample, the analysis system including a base with a sample positioned on a surface of said base and a first oscillator that directly applies a first acoustic wave at a first frequency to a probe. The analysis system further includes a second oscillator, independent of the first oscillator, that applies a second acoustic wave at a second frequency to the sample, wherein the first frequency is different than the second frequency and the first acoustic wave and the second acoustic wave are simultaneously applied to the probe and the sample, respectively, and form a coupling. The analysis system includes a source of electromagnetic energy that applies the electromagnetic energy to the sample, wherein the electromagnetic energy is absorbed by the sample causing a change in phase of the second acoustic wave. The probe interacts with the sample and is sensitive to the second acoustic wave and the change in phase of the second acoustic wave and generates signals representative of an effect of the coupling and a processor for receiving the signals and determining a spectrum of the sample based on the signals.

A second aspect of the present invention regards a method for determining chemical characteristics of a sample, the method including directly applying a first acoustic wave at a first frequency to a probe and applying, independent of the directly applying the first acoustic wave, a second acoustic wave at a second frequency to the sample, wherein the first frequency is different than the second frequency and the first acoustic wave and the second acoustic wave are simultaneously applied to the probe and the sample, respectively, and form a coupling. The method further including applying electromagnetic energy to the sample, wherein the electromagnetic energy is absorbed by the sample causing a change in phase of the second acoustic wave. The method further including detecting an effect of the coupling and determining a spectrum of the sample based on the detecting.

A third aspect of the present invention regards an analysis system for determining chemical characteristics of a sample, the analysis system including a source of electromagnetic energy that applies the electromagnetic energy to the sample, wherein the electromagnetic energy is absorbed by the sample and causes an acoustic wave to be generated. The analysis system includes a scanning near field ultrasonic holography system that receives the acoustic wave so that a coupling results wherein a change in phase of the acoustic wave results. The analysis system further includes a detector for detecting the acoustic wave and an effect of the coupling and a processor for receiving the signals and determining a spectrum of the sample based on the signals.

One or more aspects of the invention provide the advantage of the acquisition of spatial surface and sub-surface information of a sample simultaneously with the acquisition of chemical (spectral) characteristics of the same sample.

Another possible advantage of one or more aspects of the present invention is the ability to detect embedded nanostructures without the need for a destructive approach.

Further characteristics and advantages of the present invention will become apparent in the course of the following description of an exemplary embodiment by the drawings.

### BRIEF DESCRIPTION OF THE DRAWINGS

FIG. 1 shows an embodiment of an analysis system in accordance with the present invention;

FIG. 2 schematically shows the analysis system of FIG. 1;

FIG. 3A shows differential phase changes for an acoustic wave when illuminated with discrete wavelengths corresponding to adsorption of light by rhodamine 6G;

FIG. 3B shows differential phase changes for an acoustic wave when illuminated with discrete wavelengths corresponding to adsorption of light by hexamethylindotricarbocyanine;

FIG. 4 shows a possible spectrum of the microcantilever of the analysis system of FIGS. 1-2 when illuminated with infra-red light;

FIG. 5A shows a plot when an infra-red beam of light is transmitted through a sample and a standard FT-IR detector is used to detect the transmission;

FIGS. 5B-D show plots when an infra-red beam of light is transmitted through a sample and a microcantilever probe is used to detect the transmission;

FIG. 5E shows enlarged portions of the plots of FIGS. 5A-D;

FIG. 6 shows a display of amplitude and phase information in a coupled mode as generated by the analysis system of FIGS. 1-2;

FIG. 7 shows a second embodiment of an analysis system in accordance with the present invention;

FIG. 8 shows a third embodiment of an analysis system in accordance with the present invention; and

FIG. 9 shows a fourth embodiment of an analysis system in accordance with the present invention.

### DETAILED DESCRIPTION OF THE PREFERRED EMBODIMENTS

In the embodiments of the invention described hereinafter, like numerals will be used to identify like elements. In addition, one or more of the described embodiments will employ a reverse photoacoustic effect method wherein an acoustic wave is applied to a sample as a probe beam to investigate the effect of infrared absorption by the sample. The reverse photoacoustic method can be used to obtain spectroscopic information on samples.

The principle of the reverse photoacoustic effect can be simply stated. As an example, a first acoustic wave is generated from a source and directed through a first side of a sample and an acoustic wave is detected with a sensitive detector, such as a piezoelectric detector, on the opposite side, wherein the phase difference between the first acoustic wave generated by the source and the acoustic wave detected by the detector is determined. A second acoustic wave is generated by the source at the same frequency as the first acoustic wave and is directed through the first side of the sample while the sample is illuminated with a certain wavelength of infrared light (IR) and the phase difference is noted. The above described process is repeated by applying different wavelengths for the infrared light while maintaining the same frequency for the second acoustic wave.

When the sample absorbs the infrared light, the vibrational states of the constituent molecules modify the velocity of the second acoustic wave through the sample, and, thus, the phase of the second acoustic wave is modified. If a sample absorbs more energy from the infrared light, there is a greater change in phase. A plot of the phase difference with and without illumination as a function of the incident wavelength of the infrared illumination will show a unique absorption spectrum of the sample. The spectroscopic aspect of this innovation brings selectivity to detection.

The observed phase change in the reverse photo-acoustic effect is a result of the light-induced local temperature increase and the thermal expansions of the sample and nearby medium. The speed of sound v in a gas can be written as:

$$v = \sqrt{\frac{E}{ρ}}$$

wherein, v is the velocity of the first and second acoustic wave, E is the Young's modulus, and ρ is the density of the material. Since Young's modulus varies with local temperature, the velocity of the first and second acoustic wave depends on the local temperature of the medium. The possibility also exists for the velocity of the first and second acoustic waves to vary due to density change. When a sample absorbs infrared waves the individual atoms and molecules undergo electronic and vibrational excitations depending on the energy of the exciting wave. Once excited the atoms and molecules relax, they dissipate energy which results in a local change in the temperature. The sound velocity is modified due to local change in temperature. Although these changes in velocity are extremely small to be measured, its effect can be easily seen in the phase of the wave. As long as the interaction time of the electromagnetic waves with the molecules, or the relaxation time, is large enough to affect the propagating acoustic wave, there will be an observable change in phase of the acoustic wave.

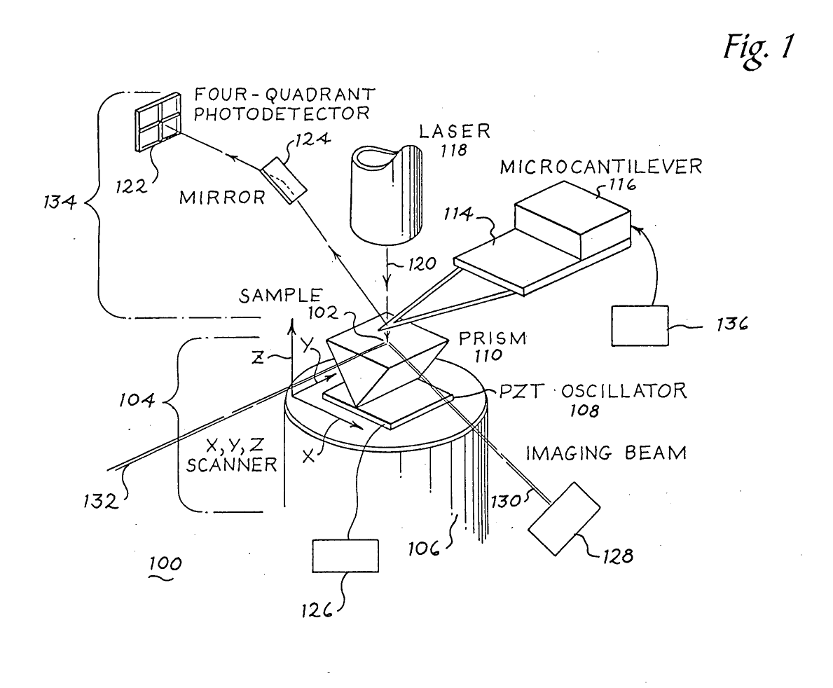

With the above description in mind, an analysis system 100 is shown in FIG. 1. In this embodiment, the sample 102 is attached to a piezoelectric sample holder 104 capable of vibrating the sample 102 at MHz frequencies. The sample holder 104 includes a base 106, a first oscillator, such as a bimorph/piezoelectric crystal (PZT) oscillator 108, an optical element, such as a 45° prism 110. The prism 110 may be replaced by a cylindrical ZnSe prism. Depending on the AFM system used, either the microcantilever 116 or the sample 102 can be moved in x-y direction. In other words, the position of the probe/microcantilever 116 with respect the sample 102 can be changed in the x-y direction. The PZT oscillator 108 is glued to the prism 110 at a location that enables ultrasonic excitation of the sample 102 from the bottom of the sample 102, in order to access subsurface information. The PZT oscillator 108 can be in the range of kHz-MHz, wherein the limit on its frequency is imposed by the bandwidth of the other pieces of equipment of the system 100.

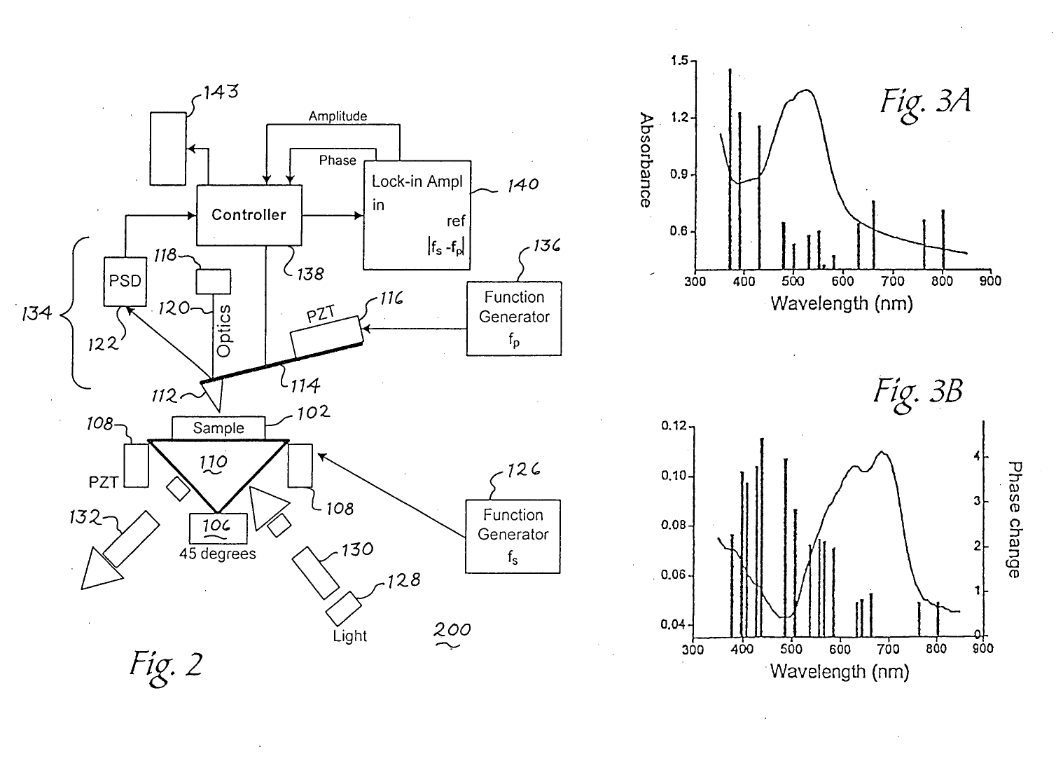

The sample 102 is placed on top of the prism 110 so that there is good contact between the two. In addition, the sample 102 is in contact with a tip 112 of a microcantilever 114 of an atomic force microscope (AFM). As shown in FIG. 2, a second oscillator, such as a PZT oscillator 116, is coupled to the microcantilever 114. A first light source, such as laser diode 118, generates a beam 120 of light that is directed toward the microcantilever 114 and is reflected toward a detector, such as a four-quadrant photodetector 122. A mirror 124 or other optical elements may direct the reflected light toward the photodetector 122. Besides the above described optical deflection system, it would be possible to use a piezoresistive or piezoelectric method, in which case the microcantilever 114 would be of different composition.

In operation, a reverse photoacoustic effect is initially analyzed by inactivating the PZT oscillator 116 and having the PZT oscillator 108 controlled by a first function generator 126 so that the PZT oscillator 108 generates acoustic waves at a frequency of fₛ and amplitude aₛ. The acoustic waves have a frequency fₛ with a value ranging from a few kilohertz to a few megahertz. The acoustic waves travel through the sample 102 at ultrasonic speeds and are sensed by the microcantilever 114. Besides being subjected to the acoustic waves generated by PZT oscillator 108, the sample 102 is illuminated from below using evanescent waves of light. In particular, a second light source, such as laser 128, directs light 130 at a fixed frequency through prism 110. The light 130 generated by laser 128 is preferably infrared (IR) light that is collimated prior to entering the prism 110. A portion 132 of the light 130 is totally internally reflected by the prism 110 and exits the prism 110. Another portion of the light 130 interacts with the sample 102 to set up an evanescent wave field that is exponentially decaying into the ambient. As a result of this interaction, the molecular vibrations in the sample 102 create localized temperature changes depending on the chemical composition of sample 102 and affect the phase of the ultrasonic acoustic waves traveling from the PZT oscillator 108 to the tip 112 of the microcantilever 114 through the sample 102. The ultrasonic acoustic wave and its phase are detected via the motion of the tip 112. Motion of the tip 112 is detected by an optical beam deflection method, piezoresistive method or a piezoelectric method.

Note that light 130 can cover ultraviolet, visible, or infrared light. In the case of light 130 being infrared light, the prism 110 is preferably made of ZnSe, Ge or ZnS. In the case of ultraviolet or visible light, the prism 110 is made of quartz. As mentioned previously, the second light source that generates light 130 can be a laser 128, wherein the laser can be tunable such as a quantum cascade laser. The second light source can also be a scanning monochromator, a spectrophotometer, or the light source of a Fourier Transform Infrared spectrometer.

An example of the optical beam deflection method is shown in FIGS. 1 and 2. In particular, laser 118 generates a beam 120 of light that is directed toward the microcantilever 114 and is reflected toward photodetector 122. The reflected beam contains information regarding the deflection undergone by the tip 112.

The above described process is repeated for different wavelengths for the light 130 while maintaining a constant frequency fₛ of the acoustic wave. After the different wavelengths for the light 130 are applied and detected, the light 130 is turned off and the above described process is repeated by maintaining the frequency fₛ of the function generator 126 and detecting the resultant deflection of the tip 112. Of course, the order of turning on or off the light 130 can be reversed.

As shown in FIGS. 3A and 3B, when sample 102 is either rhodamine 6G (FIG. 3A) or hexamethylindotricarbocyanine (FIG. 3B) that are adsorbed on quartz slides, differential phase changes for an acoustic wave are generated. As described previously, the samples are subjected to 1) an acoustic wave in reflection mode and 2) infrared light 130. Without being bound to any particular theory, the characteristics of the sound waves (e.g., velocity) passing through the samples 102 are affected when the samples 102 absorbs the infrared light 130, due to increased rotational (vapor) and vibration energy (local temperature) of the molecules of the samples 102. Then the phase difference of the acoustic waves with and without infrared illumination gives information on the absorbance of the infrared light by the samples 102. A plot of the phase difference as a function of illuminating wavelengths shows the absorption spectrum of the samples 102, which can be used to identify the chemical signature of the samples 102. A robust phase difference between the non-illuminated and infrared illuminated scenarios is observed.

The phase changes using the above described reverse photoacoustic technique are shown as vertical bars in FIGS. 3A-B while the continuous line shows absorption spectra. The samples are illuminated with discrete wavelengths of the light 130. Note that while discrete wavelengths of light 130 are used in FIGS. 3A-B, it is possible to use continuous wavelengths to increase the resolution of the spectrum. From the data shown in FIGS. 3A-B, it is clear that the phase change of the acoustic beam follows very closely the optical absorption spectra.

While the reverse photoacoustic technique of FIGS. 1-3B described previously can be performed alone, it can also be performed in conjunction with an imager known as Scanning Near-field Ultrasound Holography (SNFUH) leading to a novel imaging tool, Scanning Near-field Acoustic Photothermal/photoacoustic Spectroscopy (SNAPS), that can achieve chemical speciation with nanometer resolution. The SNFUH imager allows for simultaneous surface or subsurface imaging of a sample while the reverse photoacoustic technique is performed.

In the case of the above described holographic imaging, the image contrast comes from variation in sound velocity due to elastic property differences. Illuminating the sample using infrared waves such that the sample is in the evanescent field will result in a different phenomenon. Certain molecules will absorb infrared light creating a localized change in temperature, which in turn changes the image contrast. Image contrast as a function of wavelength will resemble a chemical map of the sample at a given fixed wavelength. The variation of the signal of the microcantilever 114 at a given fixed point of the sample 102, when scanning the wavelength, will resemble an IR absorption spectrum of the sample 102. This technique has the potential of obtaining chemical information at 5 nm resolution. An atomic force microscopy system 134 involves the microcantilever 114 and tip 112 that perform x-y-z scanning of the top surface of the sample 102 by use of the x-y movement of the base 106. The atomic force microscopy system 134 is operated to image and monitor 1) the topography of the sample 102 and 2) the response of the sample 102 to the light 130. The microcantilever 114 is optimized to be extremely sensitive to temperature changes (while keeping a high resolution imaging). One example of such optimization is to have the microcantilever 114 be made of a bimaterial by depositing a metal layer on its surface. Therefore, the microcantilever 114 response is related to the photothermal effect. A plot of the microcantilever 114 response as a function of illuminating wavelength of light 130 shows infrared absorption spectra of the sample 102.

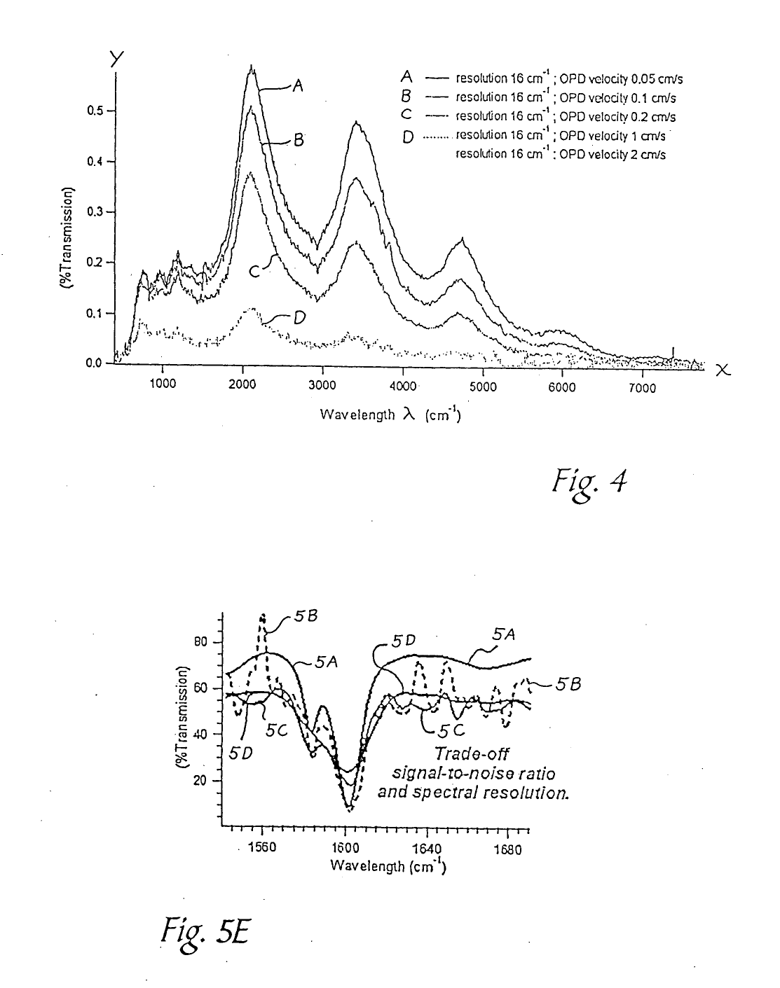

Note that prior to determining the infrared absorption spectra of the sample 10, a spectra representing the signature of the microcantilever 114 alone is performed without the sample present. An example of such spectra is shown in FIG. 4. In particular, FIG. 4 represents the spectrum of the microcantilever 114 when illuminated with IR light and performing a scan using Fourier Transform-Infra-Red Spectrometry (FT-IR). The x-axis regards the wavelength of the infra-red light applied and the y-axis regards percent transmission of light which is related to the amount of deflection of the microcantilever 114. The different curves A-E represent the evolution of the signal when scanning with different scanning velocities (0.05 cm/s, 0.1 cm/s, 0.2 cm/s, 1 cm/s, 2 cm/s) of the microcantilever 114. Such measurements aid in determining the influence of various parameters of the response of the microcantilever 114. The above described spectra of the microcantilever 114 are treated as background when processing the spectra with the sample 102 present.

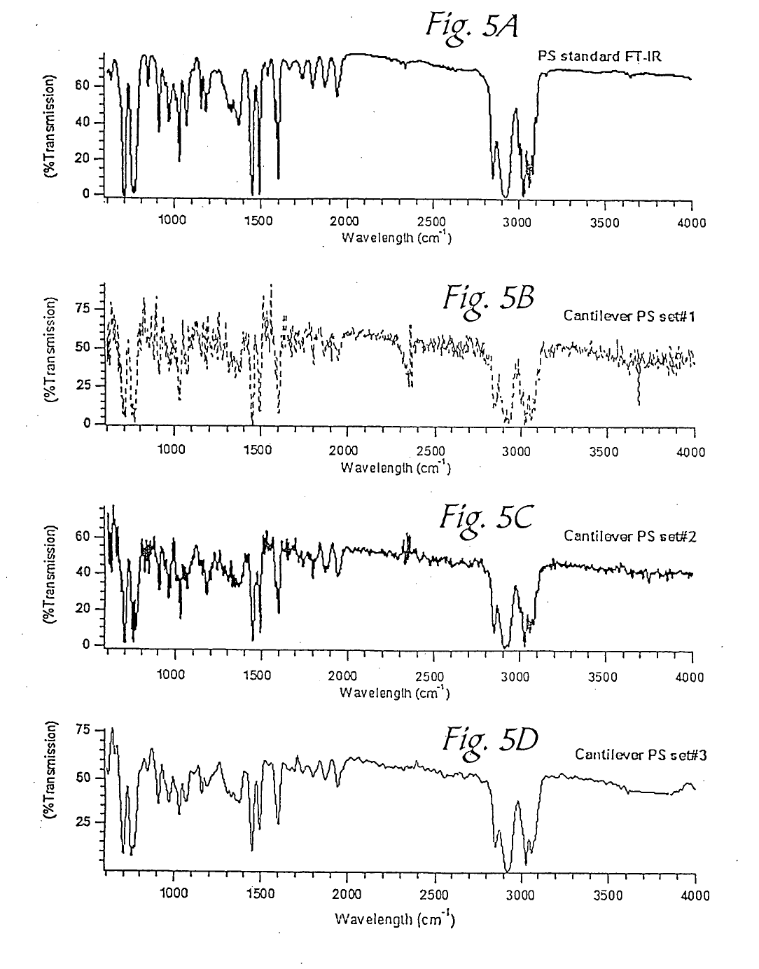

As shown in FIGS. 5A-E, the response of the microcantilever 114 and the response of a standard FT-IR detector are comparable. In particular, FIG. 5A shows the situation wherein a polystyrene film (PS) is used as the sample 102 and placed in the path of an infra-red beam of light and a standard FT-IR detector is used to measure the percent of transmission spectrum of the infra-red light through the sample. Using the same sample and replacing the standard FT-IR detector with the microcantilever 114, then various spectra are generated as shown in FIGS. 5B-D. In particular, FIGS. 5B-D show the situations using various parameters (resolution and scan velocity) for the measurement. For example, FIG. 5B represents a measurement at a resolution of 4 cm⁻¹ and scanning speed 0.2 cm/s, FIG. 5C represents a measurement at a resolution of 8 cm⁻¹ and scanning speed 0.05 cm/s, FIG. 5D represents a measurement at a resolution of 16 cm⁻¹ and scanning speed 0.05 cm/s. Note that FIG. 5E is an enlarged view of the plots of FIGS. 5A-D on the area 1560-1680 cm⁻¹. The 5A curve is the standard and represents the spectrum that we are trying to reproduce using the microcantilever 114. The curve 5C seems like the best trade-off between resolution and noise.

As shown in FIG. 2, the second PZT oscillator 116 is glued to the microcantilever 114. The PZT oscillator 116 is connected to a second function generator 136 and excited using a sine wave at frequency fₚ and amplitude aₚ. The frequency fₚ is chosen such that the microcantilever 114 is vibrated by a second piezoelectric crystal attached to the cantilever mount. In order to read out the deflection of the microcantilever 114, the optical defection system is generally used as shown in FIGS. 1-2. In the optical deflection system, the laser diode 118 generates a beam 120 that is aligned on the top surface of the microcantilever 114 and reflected to the position sensitive detector (PSD) 122. As pointed out earlier SNFUH is capable of providing nanometer resolution in imaging since the microcantilever 114 is responding to acoustic waves at the contact point of a few nanometers. Note that the components of the acoustic wave excitation not normal to the cantilever bending axis are significantly smaller than the component normal to the bending axis since the spring constant of the microcantilever 116 is 100 times smaller in the normal direction as compared to flexural directions. The acoustic waves arriving at the tip 112 may also be caused by the optical excitation caused by beam 130. The optical excitation may have the advantage of much higher signal to noise ratio as the coupling, due to the interaction of the sample 102 and the tip 112 of the cantilever 114, will be essentially limited to regions of optical absorption unless the sample as whole absorbs strongly in the infrared, in which case the situation will be similar to acoustic excitation, where a coupling may be observed regardless of whether the probe is in the vicinity of the chemical in question or away from it. However, the strength of the coupling, in this case, will more critically depend upon the thermal properties of the sample. In this sense, the optical excitation of the sample oscillations is more restrictive (sample type dependent) than the general case of acoustically oscillated sample plus infrared spectroscopy of the chemical species in question.

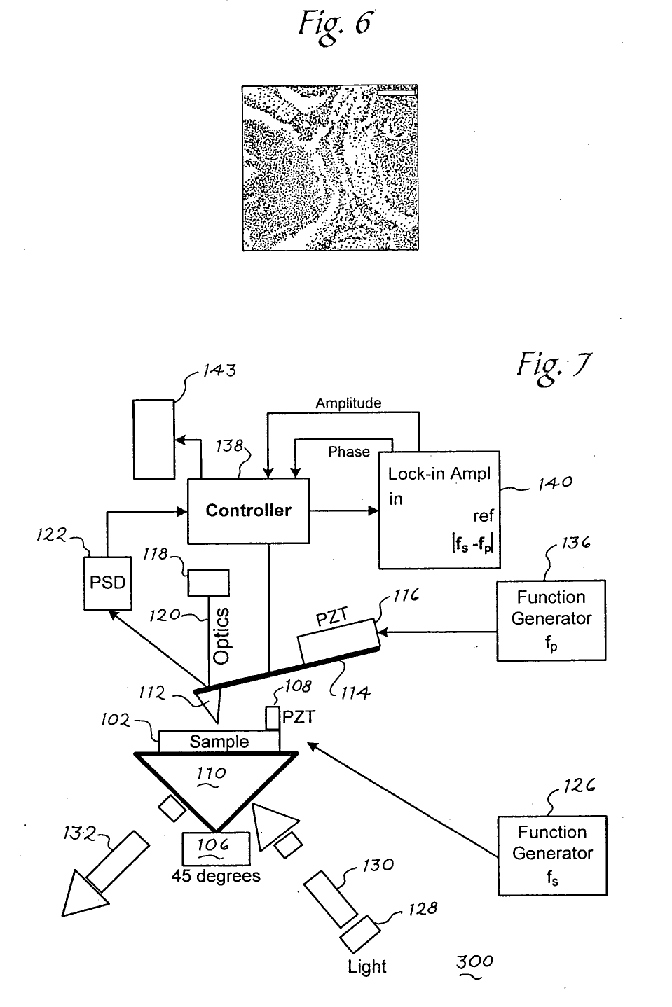

The signal generated by detector 122 is then sent to the controller 138 which processes the signal for image formation and further maneuvers the tip 112 over the sample 102. Regarding image formation, the signal from detector 122 is sent, via controller 138, to a lock-in amplifier 140 to monitor the nonlinear coupling resulting from the excitation of the microcantilever 114 and the sample 102 brought in contact with one another. The lock-in amplifier 140 extracts the amplitude and the phase corresponding to the component of the signal with a frequency of |fs−fp|. The amplitude and phase signals extracted by the lock-in amplifier 140 are sent back to the controller 138, wherein AFM software contained within the controller 138 operates on the amplitude and phase signals so as to generate regular AFM images. The amplitude and phase information in the coupled mode (in the form of |fs−fp|, used as reference in the lock-in amplifier 140) are detected and are displayed on display 143 as a function of spatial location of the scanning cantilever tip 112 as shown in FIG. 6. In this configuration, the region of interest of the sample 102 should be imaged prior to ultrasonic or electromagnetic excitation. Then, the same region should be imaged using the ultrasonic excitation and monitoring the coupling at the difference frequency |fs−fp|. Finally, it will be imaged while illuminating the sample with light.

In summary, the system 100 of FIGS. 1-2 performs two separate operations. In one operation, one acoustic wave is applied to the sample 102 and another to the probe/cantilever 114 while the beam of light 130 applied to sample 102 is at a fixed wavelength. In this operation, the image recorded (deflection, amplitude and phase mapping) will represent the response of the sample 102 to the given wavelength. In other words, if the wavelength corresponds to an identified vibration of a compound contained in the sample, chemical mapping of the sample can be obtained.

In the other operation, the acoustic waves are applied to the sample 102 and the probe 114 while a multi-wavelength beam of light 130 is applied to sample 102. In this operation, the microcantilever 114 will be used to record the localized spectrum of the sample 102. The initial image will be used to determine the location of interest, the microcantilever 114 will be positioned and the scanning light source activated. By monitoring the evolution of the deflection of the microcantilever 114, as well as the evolution of the amplitude and phase of the coupling, one will obtain the chemical signature of the sample 102 at the nanoscale.

An alternative variation of the embodiment of FIGS. 1-2 is shown by the system 200 of FIG. 7. In this embodiment, the system 100 of FIGS. 1-2 is varied by having the PZT oscillator 108 glued to the top surface of the sample 102 and connected to a function generator to drive it at frequency fₛ and amplitude aₛ. When the PZT oscillator 108 is activated an acoustic wave is generated on the surface of the sample 102. This surface acoustic wave excites the sample 102 in several directions related to the sample surface. Just as in the holographic case of FIGS. 1-2, the microcantilever tip 112 in contact with the sample 102 is excited also into lateral oscillations by these waves. The lateral spring constant of the microcantilever is an order of magnitude higher than that in the normal direction. The lateral vibrations of the microcantilever can be measured sensitively using the PSD detector 122 just as in the case of the embodiment of FIGS. 1-2 lateral force (frictional force) operation. The advantage of the mode using lateral motion is that the image is primarily sensitive to surface features. This technique will be capable of producing optical (infrared) absorption spectra of the surface features.

A second alternative variation of the embodiment of FIGS. 1-2 is shown by the system 300 of FIG. 8. In this embodiment, the embodiment of FIGS. 1-2 is altered by moving laser 128 so that when its light is directed by a fiber optic element 142 to the top surface of the sample 102. Such positioning means there is no need to use prism 110. Another variation is to replace the PZT oscillator 108 with a PZT oscillator 144 that is a layer in the substrate of the sample (since the light is brought from the top of the sample, there is no need for access to the bottom of the sample 102 anymore and the PZT oscillator 144 can be glued to the bottom of the sample 102). In this embodiment, the operation of the system is similar to the one described in the embodiment of FIGS. 1-2. The light 130 illuminates the top of the sample 102. The fiber 142 can be independently positioned close to the sample 102 or can be incorporated into the probe (using a waveguide cantilever such as those used in a Nearfield Scanning Optical Microscope (NSOM)). Note that illuminating the sample 102 from the top will require some adjustment to subtract the response of the microcantilever 114 from the resulting spectrum/image recorded (data processing or engineering on the microcantilever 114).

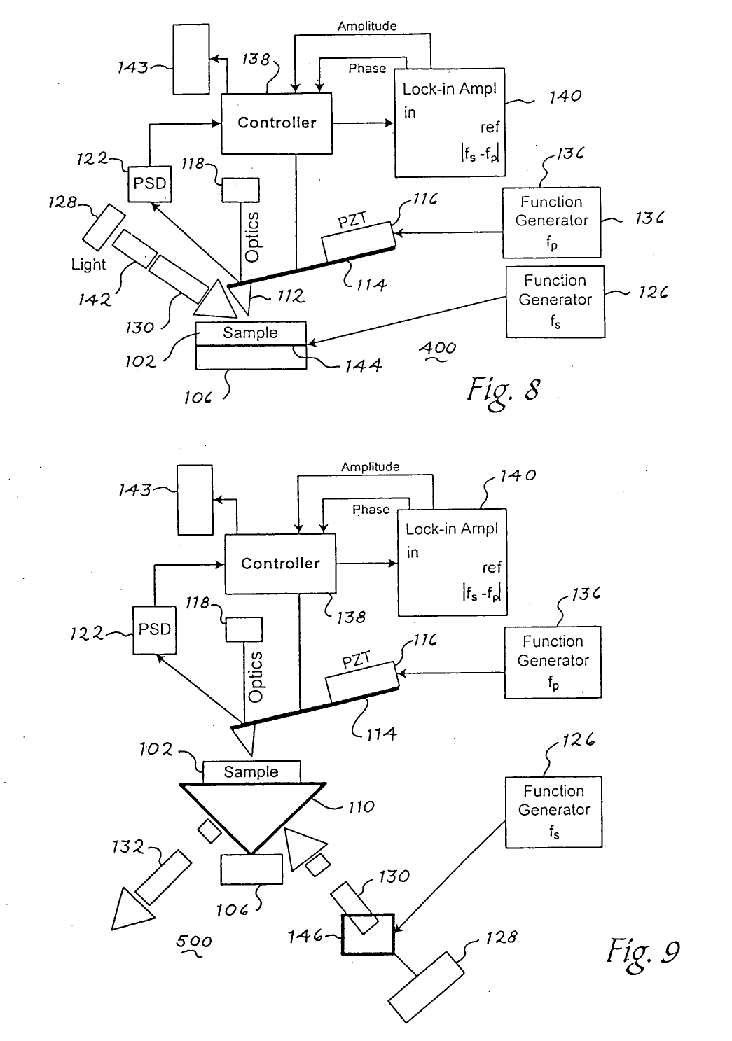

A third alternative variation of the embodiment of FIGS. 1-2 is shown by system 500 of FIG. 9. In this embodiment, the system 100 of FIGS. 1-2 is varied by removing PZT oscillator 108 and modulating the amplitude of infrared beam 130 by using a modulator such as a mechanical chopper 146 (if working with low frequencies) or an acousto optic modulator (for higher frequencies) driven at a frequency fₛ. Oscillations in the sample 102 are caused by the absorption of the amplitude modulated infrared beam 130 directly. No other acoustic activation is involved in the sample 102. The modulation frequency of the infrared beam 130 is tuned to obtain a coupling. Samples 102 that are highly absorptive in the infrared may also be examined for heterogeneity as the resolution is again mainly determined by the size of the probe tip. Of particular use are nanocomposite samples that are of transparent matrix but highly absorptive nanoinclusions. The photoacoustically generated waves couple to the cantilever vibrations with a phase that can be monitored to create an image with a contrast that originate from the nanoinclusions.

In system 500, the amplitude of the excitation will depend on the intensity of the light source 128, and the chemical composition of the sample 102. The region of interest of the sample 102 should be imaged first, using standard techniques. Then the same region should be imaged using the ultrasonic excitation of the microcantilever 114 and the illumination of the sample 102, and monitoring the coupling at the difference frequency |fs−fp|. One wavelength at a time should be used to illuminate the sample 102.

The foregoing description is provided to illustrate the invention, and is not to be construed as a limitation. Numerous additions, substitutions and other changes can be made to the invention without departing from its scope as set forth in the appended claims. For example, the previously described SNFUH imager can be applied to the reverse photoacoustic systems of FIGS. 4-7 to allow for simultaneous surface or subsurface imaging of a sample while the reverse photoacoustic technique is performed.

We claim:

1. An analysis system for determining chemical characteristics of a sample, the analysis system comprising:
a base with a sample positioned on a surface of said base;
a first oscillator that directly applies a first acoustic wave at a first frequency to a probe;
a second oscillator, independent of said first oscillator, that applies a second acoustic wave at a second frequency to said sample, wherein said first frequency is different than said second frequency and said first acoustic wave and said second acoustic wave are simultaneously applied to said probe and said sample, respectively, and form a coupling;
a source of electromagnetic energy that applies said electromagnetic energy to said sample, wherein said electromagnetic energy is absorbed by said sample causing a change in phase of said second acoustic wave;
wherein said probe interacts with said sample and is sensitive to said second acoustic wave and said change in phase of said second acoustic wave and generates signals representative of an effect of said coupling; and
a processor for receiving said signals and determining a spectrum of said sample based on said signals.

2. The analysis system of claim 1, further comprising an imager that allows for simultaneous surface or subsurface imaging of said sample.

3. The analysis system of claim 1, further comprising a scanning near field ultrasonic holography system that images said sample.

4. The analysis system of claim 3, wherein probe comprises a cantilever tip that is in contact with a surface of said sample while said sample is subjected to said second acoustic wave, wherein said scanning near field ultrasonic holography system comprises said cantilever tip.

5. The analysis system of claim 4, wherein said cantilever tip is excited by a photothermal field.

6. The analysis system of claim 4, wherein said cantilever tip is excited by said first acoustic wave.

7. The analysis system of claim 1, wherein said probe comprises a cantilever tip that is in contact with a surface of said sample while said sample is subjected to said second acoustic wave.

8. The analysis system of claim 7, wherein said cantilever tip is bimaterial.

9. The analysis system of claim 1, wherein said second acoustic wave is generated by exciting a surface of said sample.

10. The analysis system of claim 1, further comprising a fiber optic element to direct said electromagnetic energy from said source to said sample.

11. A method for determining chemical characteristics of a sample, the method comprising:
directly applying a first acoustic wave at a first frequency to a probe;
applying, independent of said directly applying said first acoustic wave, a second acoustic wave at a second frequency to said sample, wherein said first frequency is different than said second frequency and said first acoustic wave and said second acoustic wave are simultaneously applied to said probe and said sample, respectively, and form a coupling;
applying electromagnetic energy to said sample, wherein said electromagnetic energy is absorbed by said sample causing a change in phase of said second acoustic wave;
detecting an effect of said coupling; and
determining a spectrum of said sample based on said detecting.

12. The method of claim 11, further comprising simultaneous imaging a surface or subsurface of said sample.

13. The method of claim 11, further comprising imaging said sample with a scanning near field ultrasonic holography system that images said sample.

14. The method of claim 13, wherein said probe comprises a cantilever tip that is in contact with a surface of said sample while said sample is subjected to said second acoustic wave, wherein said scanning near field ultrasonic holography system comprises said cantilever tip.

15. The method of claim 14, wherein said cantilever tip is excited by a photothermal field.

16. The method of claim 14, wherein said cantilever tip is excited by said first acoustic wave.

17. The method of claim 11, wherein said first acoustic wave is generated by exciting said probe.

18. The method of claim 11, wherein said probe comprises a cantilever tip that is in contact with a surface of said sample while said sample is subjected to said second acoustic wave.

19. An analysis system for determining chemical characteristics of a sample, the spectrometer comprising:
a source of electromagnetic energy that applies said electromagnetic energy to said sample, wherein said electromagnetic energy is absorbed by said sample and causes an acoustic wave to be generated;
a scanning near field ultrasonic holography system that receives said acoustic wave so that a coupling results wherein a change in a phase of said acoustic wave results;
a detector for detecting an effect of said coupling and generating signals representative of said effect; and
a processor for receiving said signals and determining a spectrum of said sample based on said signals.

20. The analysis system of claim 19, wherein said scanning near field ultrasonic holography system comprises a cantilever tip that is in contact with a surface of said sample while said sample is subjected to said acoustic wave.

21. The analysis system of claim 20, wherein said cantilever tip is excited by said acoustic wave.

22. The analysis system of claim 19, further comprising a fiber optic element to direct said electromagnetic energy from said source to said sample.
